(19) United States
(12) Patent Application Publication
(10) Pub. No.: US 2006/0227352 A1
(43) Pub. Date: Oct. 12, 2006

(54) Printing press simulator

(75) Inventor: Hans-Eckhard Mamberer, Konigsbrunn (DE)

Correspondence Address: COHEN, PONTANI, LIEBERMAN & PAVANE, 551 FIFTH AVENUE, SUITE 1210, NEW YORK, NY, 10176, US

(73) Assignee: MAN Roland Druckmaschinen AG, Offenbach am Main (DE)

(21) Appl. No.: 11/397,092

(22) Filed: Apr. 4, 2006

(30) Foreign Application Priority Data
Apr. 6, 2005 (DE) 10 2005 015 746.7

(51) Int. Cl. G06K 15/00

(52) U.S. Cl. 358/1.12; 358/1.5

(57) ABSTRACT

A printing press simulator is integrated into a control desk of a printing press, it being possible for input data to be predefined by an operator on an input device of the control desk during the simulation. A simulation unit of the printing press simulator simulates the printing process and the behavior of the printing press on the basis of the input data and produces output data which can be displayed on an output device of the control desk. The printing press simulator has a database with intended image data based on the prepress stage for a specific number of customer-specific and updatable printed pages, and the printing press simulator also has a manipulation unit which, on the basis of the input data predefined by the printer, changes the intended image data based on the prepress stage and stored in the database in order to provide simulation image data.

### BACKGROUND OF THE INVENTION

1. Field of the Invention

The invention relates to a printing press simulator.

2. Description of the Related Art

During the installation or the commissioning of new printing presses, great importance is attached to the training of the operating personnel, specifically the printer operating on the printing press. For example, it takes several months until the operating personnel of a customer master the system-specific special features of a new printing press and their effects on the printing process. At this time, the availability of the machine, the net output and the achievable print quality are restricted. Furthermore, during this learning phase or accustomization phase, a disproportionate amount of rejects accumulate. All these factors give rise to high costs at the operator of a printing press.

It is therefore of importance to train the operating personnel intensively, in order that the operating personnel are made familiar with the system-specific special features of a new printing press in parallel with its installation. As a rule, however, training measures of this type can be held only theoretically, since the printing press is not available for training purposes during the construction or during the installation of the same. Nevertheless, individual operating steps can in practice be practiced on already mounted component parts of the printing press. In order nevertheless to be able to train the operating personnel, use is made of what are known as printing press simulators.

US 2001/0034592 A1 discloses a printing press simulator with the aid of which the behavior of printing presses can be simulated. Such a printing press simulator is decoupled from the printing machine, constructed as a completely autonomous device and operates on the basis of prefabricated default data, which are substantially the same for all types of printing presses and, accordingly, are not matched to the configuration of a specific printing press. Therefore, no customer-specific training operation or diagnostic operation matched to a specific printing press configuration can be run with such a printing press simulator.

### SUMMARY OF THE INVENTION

Taking this as a starting point, the present invention is based on the object of providing a novel type of printing press simulator.

The printing press simulator according to the invention is integrated into a control desk of a printing press, preferably into the original control desk of a customer-specific printing press. Input data can be predefined by an operator on input devices of the control desk during the simulation, on the basis of which data a simulation unit of the printing press simulator simulates the printing process and the behavior of the printing press and produces output data which can be displayed on output devices of the control desk. The printing press simulator has a database with intended image data based on the prepress stage for a specific number of customer-specific and updatable printed pages. The printing press simulator also has a manipulation unit which, on the basis of the input data predefined by the operator and also preferably on the basis of a printing press model stored in the simulation unit, changes the intended image data based on the prepress stage and stored in the database in order to provide simulation image data.

With the printing press simulator according to the invention, training operation for operating personnel which is matched to the actual machine configuration of a customer is possible. For example, the printing press simulator is integrated into the control desk, preferably the original control desk, of the printing press, so that all the inputs for carrying out simulations are made on the control desk of the printing press. Simulations are therefore carried out by using a real control desk. This means that training of the operating personnel which is particularly close to practice is possible. The printing press simulator according to the invention is independent of the state of development of the control desk. Thus, for training purposes, it always depicts the original state of the respective printing system.

Preferred developments of the invention emerge from the following description. Exemplary embodiments of the invention, without being restricted thereto, are explained in detail by using the drawing.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The sole FIGURE is a block diagram of a printing press simulator according to the invention.

### DETAILED DESCRIPTION OF THE PRESENTLY PREFERRED EMBODIMENTS

The FIGURE shows a block diagram of a printing press simulator 10 according to the invention, which is integrated into a control desk 11 of a printing press. Via an input device 12 of the control desk, input data 13 for the simulation can be predefined by a printer. These input data 13 are, for example, printing press-specific printing parameters or material-specific printing parameters. The printing press-specific printing parameters include, for example, settings on inking units, settings on web tension devices, settings on damping units or settings on register devices. The material-specific printing parameters include, for example, settings with regard to the printing material used and also the printing ink used.

Furthermore, the control desk 11 comprises an output device 14. On the output device 14 it is possible to visualize data which are generated with the aid of the printing press simulator 10 according to the invention on the basis of the input data 13 predefined by the printer.

The input data 13 predefined by a printer for the purpose of simulation in simulation operation are transmitted to a simulation unit 16 of the printing press simulator 10 according to the invention, with the interposition of what is known as an interpreter unit 15I The interpreter unit 15 converts the input data 13 predefined by the operator into input variables 17 for the simulation unit 16. Likewise, the interpreter unit 15 converts output variables 18 from the simulation unit 16 into output data 19, which can be visualized on the display device 14 of the control desk 11.

A system-dynamic and system-theoretical printing press model, which depicts the printing press, is stored in the simulation unit 16. The simulation unit 16 converts the input data 13, which are provided to the simulation unit 16 in the form of unconverted input variables 17, in such a way as if the same were to be implemented in a real printing process and, as a simulation result, outputs appropriate output variables 18 in simulated real time. As already mentioned, these data are converted by the interpreter unit 15 into output data 19 that can be visualized on the display device 14 of the control desk 11.

The printing press simulator 10 according to the invention comprises a database 20 and a manipulation unit 21, in addition to the components already mentioned. Stored in the database 20 are intended image data 22 based on the prepress stage for a specific number of customer-specific printed pages. On the basis of the intended image data 22, an intended printed page can be displayed on a first display device 23 of the control desk 11. This displays the intended state of a printed page to be printed to an operator to be trained.

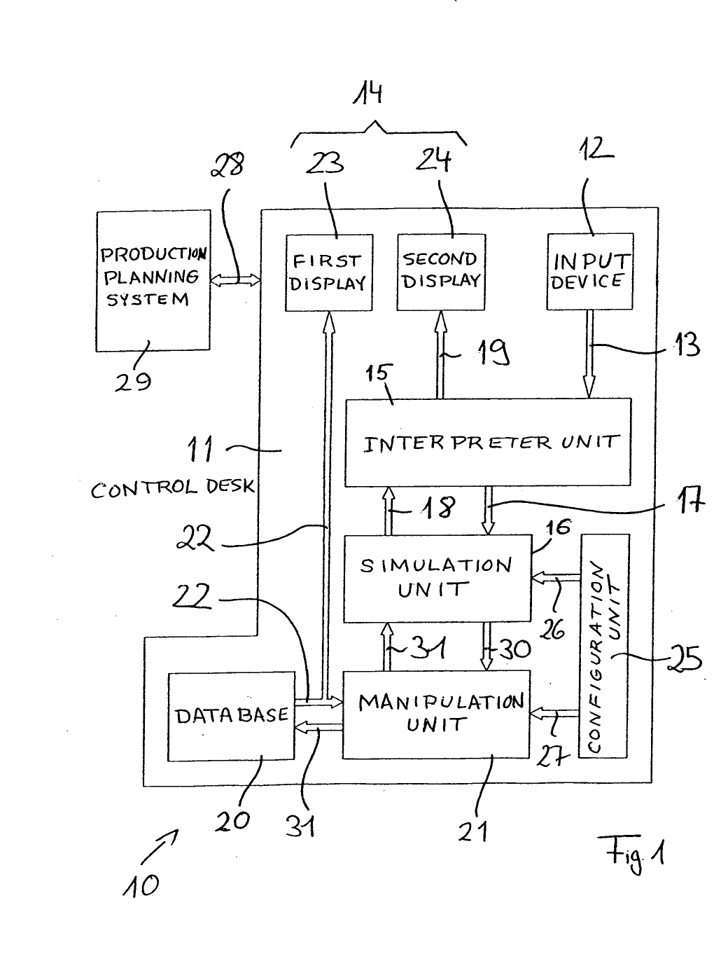

According to FIG. 1, the intended image data 22 are likewise supplied to the manipulation unit 21, the manipulation unit 21 changing the intended image data 22 based on the prepress stage on the basis of the input data 13 predefined by the operator and on the basis of the printing press model stored in the simulation unit 16 in order to provide simulation image data 31. Thus, according to FIG. 1, the manipulation unit 21 is fed by the simulation unit 16 with input data 30 which depend on the input data 13 and the printing press model. As output data, the manipulation unit 21 provides the simulation image data 31. The simulation image data generated by the manipulation unit 21 are a constituent part of the output variables 18 from the simulation unit 16, an actual printed page being displayed on a second display device 24 of the control desk 11 on the basis of the simulation image data 31.

The output device 14 can preferably be a display device which combines the display devices 23 and 24 in a soft-proof monitor. This monitor is used to display intended printed page data during real printing operation.

In the exemplary embodiment shown in FIG. 1, an intended printed page based on the intended image data 22 stored in the database 20 is accordingly displayed on the first display device 23. On the second display device 24, on the other hand, an actual printed page which is based on the simulation image data is displayed, the simulation image data being generated by the manipulation unit 21 on the basis of the input data 13 predefined by the printer and on the basis of the printing press model stored in the simulation unit 16. In this way, an operator to be trained can learn the effects of the input data 13 predefined by the same on the printing process by means of a comparison of the intended printed image displayed on the first display device 23 with the actual printed image displayed on the second display device 24.

Accordingly, an operator to be trained is given feedback in real time about the printing effects of the input data predefined by the operator during the simulation.

In this case, a simulation can be started on the basis of an intended printed page in order to learn the extent to which an actual printed page changes as compared with the intended printed page as a result of changing input data 13. Alternatively, a simulation can also be started on the basis of an actual printed page, in order to learn the input data 13 by means of which an actual printed page can be brought close to the intended printed page.

In this case, it is within the spirit of the present invention for the printing press simulator 10 to include a comparison device which compares the intended image data based on the prepress stage with the simulation image data generated. This comparison device can, for example, be a constituent part of the manipulation unit 21. On the basis of this comparison, it is possible to generate displays on a further display device of the control desk 11 in order to display to an operator to be trained information as to whether an actual printed image approaches the intended printed image or moves away from the lafter as a result of a predefined input dataset 13.

During a simulation it is also possible to reset input data predefined by an operator and in this way always to return to the initial status of the simulation. Furthermore, it is possible, during the simulation, automatically to generate help documents or help commands for an operator to be trained and to visualize them on the control desk. Help documents of this type are preferably generated on the basis of the comparison of the intended image data with the simulation image data performed in the comparison device.

The simulation image data generated by the manipulation unit 21 can be stored in the database 20, preferably together with the input data 13. As a result of retrieving the simulation image data and the corresponding input data, it is possible at a later time to evaluate training operations or training sequences in detail and to analyse them.

The printing press simulator 10 also includes a configuration unit 25. Parameter data can be input and determined via the configuration unit 25. First parameter data 26 are printing press-specific parameters in order to configure the printing press model stored in the simulation unit 16 in a customer-specific manner. Second parameter data 27 are material-specific parameters, in particular printing ink parameters and printing material parameters, in order to configure the manipulation unit 21 in a customer-specific manner. Accordingly, via the configuration unit 25, the printing press simulator 10 according to the invention can be matched individually to a customer-specific printing press configuration, in order in this way to permit tailor-made individual training of operating personnel.

The printing press simulator 10 also has an interface 28 for the attachment of a production planning system 29. The production planning system 29 used is preferably a computer system, such as is used on the real printing press. This production planning system 29 is pre-configured with all planning data and printed product data and can be attached to the printing press simulator 10 according to the invention via the interface 28 in order to provide an expanded simulation function. Therefore, it is possible for the operator to be trained or the trainee to practice real production schemes such as occur later in practice.

With the printing press simulator according to the invention, a customer-specific specific printing press is depicted for training purposes, so that a customer-specific simulation of printing processes is made possible. Operating personnel can be trained under real conditions close to practice, long before the commissioning of a printing press. In this case, all the input data predefined by an operator to be trained can be analysed with regard to their individual effects and also in combination with one another with regard to their overall effects.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A printing press simulator which is integrated into a control desk of a printing press, said simulator comprising:
an input device for an operator to predefine input data;
a database with intended image data based on the prepress stage for a predetermined number of customer specific and updatable printed pages;
a manipulation unit which changes the intended image data to simulation image data based on the input data predefined by the operator;
a simulation unit which simulates the printing process and the behavior of the printing press based on the input data and the simulation image data and produces output variables; and
an output device which displays output data based on the output variables.

2. The printing press simulator of claim 1 wherein the simulation unit stores a system dynamic and system theoretical printing press model, and simulates the printing process and the behavior of the printing press based on the input data and the printing press model in real time.

3. The printing press simulator of claim 1 further comprising an interpreter unit which converts the input data predefined by the operator into input variables which are supplied to the simulation unit, said interpreter unit converting the output variables produced by the simulation unit into the output data displayed on the output device.

4. The printing press simulator of claim 1 further comprising a first display device which displays an intended printed page based on the intended image data, said output device serving as a second display device, said second display device displaying an actual printed page as said output data.

5. The printing press simulator of claim 1 wherein the simulation image data, and the input data on which the simulation image data are based, are stored in the database.

6. The printing press simulator of claim 1 further comprising a configuration unit which inputs printing press-specific parameters to the manipulation unit for configuring a printing press model in the simulation unit in a customer specific manner.

7. The printing press simulator of claim 1 wherein the configuration unit inputs material-specific parameters to the manipulation unit for configuraing the manipulation unit in a customer-specific manner.

8. The printing press simulator of claim 1 further comprising an interface for attaching a production planning system to the simulator.

9. The printing press simulator of claim 1 further comprising a comparison device which compares the intended image data with the simulation image data and generates data for a display indicating whether the simulation image data approaches or moves away from the intended image data.
